(19) United States
(12) Patent Application Publication
(10) Pub. No.: US 2013/0072339 A1
(43) Pub. Date: Mar. 21, 2013

(54) AUTOMATIC GEARBOX TRANSMISSION SYSTEM FOR ELECTROMECHANICAL HYBRID POWER VEHICLE

(71) Applicant: Chongxin Zhang, Guangdong (CN)

(72) Inventor: Chongxin Zhang, Guangdong (CN)

(73) Assignee: Guangzhou Huau Worldwide Automatic Transmission Co. LTd, Guangdong (CN)

(21) Appl. No.: 13/576,946

(22) PCT Filed: Oct. 22, 2011
(86) PCT No.: PCT/CN2011/081154

§ 371 Date: Sep. 4, 2012

(30) Foreign Application Priority Data
Jan. 1, 2011 (CN) 2011100055250

(51) Int. Cl. F16H 3/62

(52) U.S. Cl. CPC F16H 3/62
USPC 475/159

(57) ABSTRACT

A drive train for an automatic transmission for an electromechanical hybrid vehicle is disclosed. The drive train is designed as a whole consisting of only 29 major parts and units, capable of generating 6 forward shifts and 1 reverse shift. A motor is wholly arranged on an input shaft such that the rotation speeds of the motor and the input shaft are synchronous. The motor has the functions of an electric generator and can drive a vehicle to run by a reactive force generated by the magnetic field of the electric generator such that the vehicle generates power during running and therefore avoids consuming the power of the engine due to the load of the electric generator, and thus, the aim of power conservation is achieved. In the hybrid drive mode, the vehicle does not need a clutch and a brake to shift the gear at the moment of startup and during running and therefore realizes stepless transmission and can transmit a large torque.

### BACKGROUND OF THE INVENTION

The invention relates to the technical field of hybrid vehicles, in particular to a drive train for an automatic transmission for an electromechanical hybrid vehicle.

As the continuous reduction of worldwide petroleum resources and the enhancement of environmentally-friendly consciousness of various countries in the world continues, energy conservation and emissions reduction are the current themes of vehicle development. The most environmentally-friendly and energy-saving vehicle is the electric vehicle. But the electric vehicle also has the disadvantages of long charge time and limited road-haul at present. To overcome the disadvantages of the electric vehicle, the hybrid vehicle has been developed, which has the combined advantages of electric vehicles and current vehicles, and also has the function of recovering braking energy for power generation, and therefore has become the mainstream of vehicle development.

By searching the technical patent literature of existing hybrid vehicles, it was found that the current hybrid vehicle usually has the following technical problems:

First, the drive train of the current hybrid vehicle is not integrated such that the parts of the drive train are not compact, which causes a situation where the limited space of the vehicle is occupied by the installation and connection of transmissions. For example, the patent ZL200820033442.6 “Drive Train for a Hybrid Vehicle” and the patent ZL200720123450.5 “Drive Train for an All-wheel Drive Hybrid Vehicle” have the above mentioned technical problem.

Second, the current drive trains of current hybrid vehicles fail to realize complete stepless speed change when changing speed, and usually complete the speed change via the exchange of two working components. For example, the patent ZL200710034415.0 “Stepless Speed Change Drive train for Electromechanical Planet Mechanism” and the patent ZL200710078132.6 “Drive Train of Dual Planet Gearset Multi-mode Hybrid Vehicle” have the above mentioned technical problem.

Third, the drive trains of existing hybrid vehicles usually utilize the planetary gear train; the engine drives a certain component in the planetary gear train and a motor drives a certain component in the planetary gear train, such that the two kinds of driving rotations at different speeds together drive the output component of the planetary gear train; the two kinds of drive rotating speeds are not located at the same starting point, and if the rotating speed of the engine rises, then the rotating speed of the motor also must rise such that the aim of common drive can be realized; and if the two kinds of driving rotations are unmatched, energy loss will be caused. For example, the patent ZL200620049616.9 “Drive Train for a Hybrid Vehicle” and the patent ZL200610028903.6 “Transmission for a Hybrid Vehicle” have the above mentioned technical problem.

Fourth, the power supply systems of existing hybrid vehicles fail to meet the demands of the motor on long-term power supply; on a highway, if the electric power is exhausted, the vehicle in the single engine drive mode can only run at a medium or low speed. For example, the patent 200810040912.6 “Dual Planet Gearset Electromechanical Combined Drive Unit of Hybrid Vehicle” has the above mentioned technical problem.

Five, the drive mechanism of the stepless automatic transmission used in the existing vehicle usually adopts a steel belt and a belt pulley to generate friction transmission, which has the advantages of simple structure and high transmission efficiency and the disadvantage of failing to transmit large torque. For example, the patent ZL200610037978.0 “A Stepless Automatic Transmission” has such technical problem.

### BRIEF SUMMARY OF THE INVENTION

The objective of the invention is to creatively design a drive train of an automatic transmission for an electromechanical hybrid vehicle by optimization in virtue of the advantages of the existing vehicle technologies to solve the above mentioned technical problems.

The invention is realized by the following technical scheme:

A drive train of an automatic transmission of an electromechanical hybrid vehicle comprises a flexible coupling, a one-way clutch, an input shaft, a radial thrust bearing, a rotor output shaft, a first sun gear, a first planet gear, a first inner gear ring, a first planet carrier, an intermediate driver shaft, a second sun gear, a second planet gear, a second inner gear ring, a second planet carrier, a third sun gear, a third planet gear, a third inner gear ring, a third planet carrier, an output shaft, a brake B1, a brake B2, a brake B3, a clutch K1, a clutch K2, an oil pump, an oil pump input shaft, a motor stator, a motor housing, and a drive train housing.

The flexible coupling is installed on a fly wheel of the vehicle engine and connected with the outer ring of the one-way clutch of which the inner ring is connected with the front end of the input shaft.

The front segment of the input shaft is provided with the motor housing; the middle segment of the input shaft is connected with the first sun gear; and the rear segment of the input shaft is provided with the clutch K1 and the clutch K2.

The first sun gear is engaged with the first planet gear; the first planet gear is engaged with the first inner gear ring; and the first planet gear is arranged on the first planet carrier.

The second sun gear is engaged with the second planet gear; the second planet gear is engaged with the second inner gear ring; and the second planet gear is arranged on the second planet carrier.

The third sun gear is engaged with the third planet gear; the third planet gear is engaged with the third inner gear ring; and the third planet gear is arranged on the third planet carrier.

The motor stator is arranged on the motor housing; the motor housing is arranged on the input shaft; and the rear portion of the motor housing is connected with the oil pump input shaft that is connected with the oil pump.

The rotor output shaft is arranged on the bearing of the motor housing and is connected with the first inner gear ring.

The first planet carrier is connected with the second inner gear ring.

The second planet carrier is connected with the third inner gear ring.

The third planet carrier is connected with the output shaft.

The brake B1, brake B2 and brake B3 all are arranged on the drive train housing.

The brake B1 can stop the rotor output shaft and the first inner gear ring.

The brake B2 can stop the first planet carrier and the second gear ring.

The brake B3 can stop the second planet carrier and the third gear ring.

The clutch K1 can connect the input shaft and the intermediate drive shaft as a whole.

The intermediate drive shaft is provided with a second sun gear and a third sun gear.

The clutch K2 can connect the input shaft, the second planet carrier, and the third inner gear ring as a whole.

The drive train of the automatic transmission for the electromechanical hybrid vehicle has the following six unique advantages:

First, compact structure: the drive train of the automatic transmission for the electromechanical hybrid vehicle is designed into a whole; the whole drive train only consists of 29 major parts and units and can generate 6 forward gears and 1 reverse gear; and the whole drive system has only a few parts and units, so the manufacturing cost is reduced.

Second, high energy consumption efficiency: the motor is wholly arranged on an input shaft such that the rotation speeds of the motor and the input shaft are synchronous; the motor has the functions of an electric generator and can drive a vehicle to run by a reactive force generated by the magnetic field of the electric generator such that the vehicle generates power during running and therefore avoids consuming the power of the engine because of the load of the electric generator, and thus, the aim of power conservation is achieved.

Third, smooth transmission: the motor is wholly arranged on the input shaft; when the rotor output shaft of the motor outputs power to drive the inner gear ring, and when the power of the engine is transmitted via the input shaft to drive the sun gear, the two kinds of driving forces commonly drive the planet carrier; the two kinds of driving forces come from the same input shaft, and even if they are different in rotation speed and torque, the situation where the drive rotating speeds are unmatched is avoided; and thus transmission is smooth.

Fourth, large output power: the power generated by the engine and the power generated by the magnetic field of the motor commonly drive the vehicle to run; the addition of the two kinds of power can obtain an effect equal to the power of a high-emission vehicle, but the emission is only half of the large-emission vehicle.

Five, in the invention, the front end of the input shaft is provided with a one-way clutch, so the aim of energy conservation can be realized by fully utilizing the inertia in the motion of the vehicle and the sliding of the vehicle.

Six, with the drive train of the automatic transmission for the electromechanical hybrid vehicle disclosed in the invention, the vehicle in the hybrid drive mode does not need the clutch and brake to change gears at the moment of startup and during running, and therefore realizes stepless speed change and can transmit a large torque.

The drive train of the automatic transmission for the electromechanical hybrid vehicle disclosed in the invention comprises the following three modes: 1, pure motor drive mode, which is mainly applicable to running in the city for reducing air pollution;

2, engine drive mode, which is mainly applicable to running on a highway, wherein when the vehicle is running and the electricity generation function is conducted to accumulate electricity;

3, hybrid drive mode, which enables the vehicle to obtain a large driving force.

### BRIEF DESCRIPTION OF THE DRAWINGS

FIG. 1 is a schematic view of a drive train of an automatic transmission of an electromechanical hybrid vehicle: flexible coupling 1, one-way clutch 2, input shaft 3, radial thrust bearing 4, rotor output shaft 5, first planet gear 6, first sun gear 7, first planet carrier 8, intermediate drive shaft 9, second planet gear 10, second sun gear 11, second planet carrier 12, third planet gear 13, third sun gear 14, third planet carrier 15, output shaft 16, third inner gear ring 17, brake B3 18, second inner gear ring 19, brake B2 20, clutch K2 21, clutch K1 22, first inner gear ring 23, brake B1 24, oil pump 25, oil pump input shaft 26, motor stator 27, motor housing 28 and drive train housing 29.

FIG. 2 is the power transmission route chart of a gear 1 in an engine drive mode;

FIG. 3 is the power transmission route chart of a gear 2 in the engine drive mode;

FIG. 4 is the power transmission route chart of a gear 3 in the engine drive mode;

FIG. 5 is the power transmission route chart of a gear 4 in the engine drive mode;

FIG. 6 is the power transmission route chart of a gear 5 in the engine drive mode;

FIG. 7 is the power transmission route chart of a gear 6 in the engine drive mode;

FIG. 8 is the power transmission route chart of a reverse gear in the engine drive mode;

FIG. 9 is the power transmission route chart of a forward gear in a pure motor drive mode;

FIG. 10 is the power transmission route chart of a reverse gear in the pure motor drive mode;

FIG. 11 is the power transmission route chart of a neutral position in a hybrid drive mode;

FIG. 12 is the power transmission route chart of forward stepless speed change in the hybrid drive mode;

In FIGS. 2-12, the heavy lines with arrows represent the transmission routes of the driving force; the heavy lines without arrows represent the braked routes; and the thin lines represent connecting lines of the drive train housing.

### DETAILED DESCRIPTION OF THE INVENTION

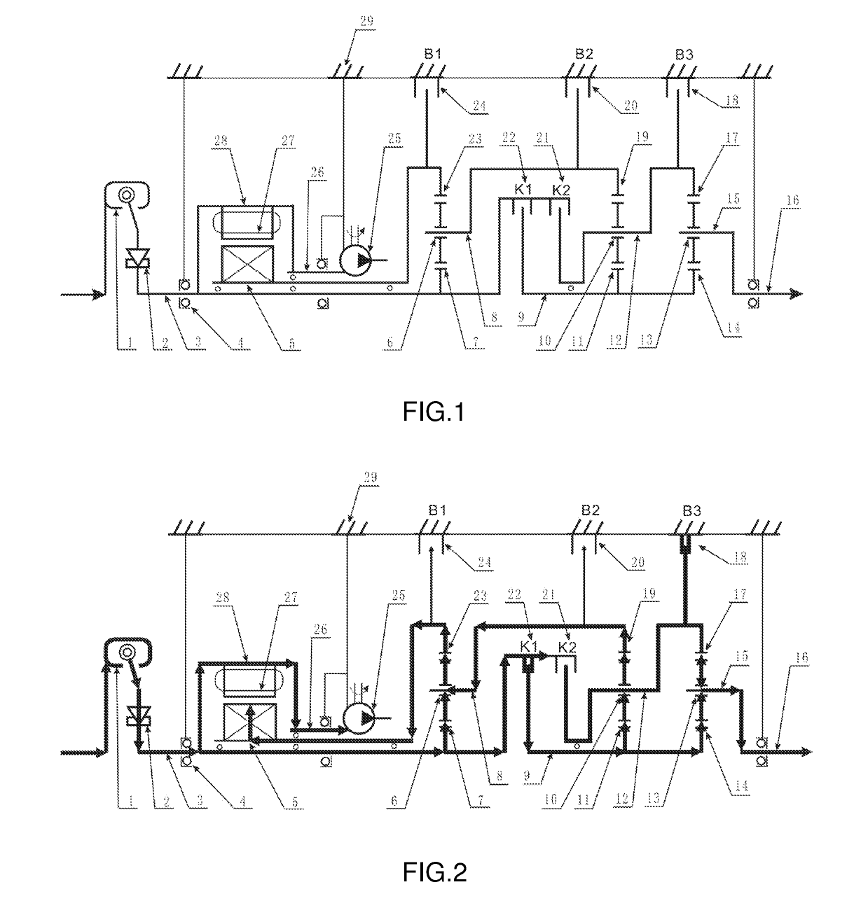

As shown in FIG. 1, a drive train of an automatic transmission of an electromechanical hybrid vehicle comprises a flexible coupling 1, a one-way clutch 2, an input shaft 3, a radial thrust bearing 4, a rotor output shaft 5, a first planet gear 6, a first sun gear 7, a first planet carrier 8, an intermediate drive shaft 9, a second planet gear 10, a second sun gear 11, a second planet carrier 12, a third planet gear 13, a third sun gear 14, a third planet carrier 15, an output shaft 16, a third inner gear ring 17, a brake B3 18, a second inner gear ring 19, a brake B2 20, a clutch K2 21, a clutch K1 22, a first inner gear ring 23, a brake B1 24, an oil pump 25, a oil pump input shaft 26, a motor stator 27, a motor housing 28 and a drive train housing 29.

As shown in FIG. 1 of the description, the flexible coupling 1 is installed on a fly wheel of the vehicle engine and connected with the outer ring of the one-way clutch 2 of which the inner ring is connected with the front end of the input shaft 3.

As shown in FIG. 1 of the description, the front segment of the input shaft 3 is provided with the motor housing 28; the middle segment of the input shaft 3 is connected with the first sun gear 7; and the rear segment of the input shaft 3 is provided with the clutch K1 22 and the clutch K2 21.

As shown in FIG. 1 of the description, the first sun gear 7 is engaged with the first planet gear 6; the first planet gear 6 is engaged with the first inner gear ring 23; and the first planet gear 6 is arranged on the first planet carrier 8.

As shown in FIG. 1 of the description, the second sun gear 11 is engaged with the second planet gear 10; the second planet gear 10 is engaged with the second inner gear ring 19; and the second planet gear 10 is arranged on the second planet carrier 12.

As shown in FIG. 1 of the description, the third sun gear 14 is engaged with the third planet gear 13; the third planet gear 13 is engaged with the third inner gear ring 17; and the third planet gear 13 is arranged on the third planet carrier 15.

As shown in FIG. 1 of the description, the motor stator 27 is arranged on the motor housing 28; the motor housing 28 is arranged on the input shaft 3; and the rear portion of the motor housing 28 is connected with the oil pump input shaft 26 which is connected with the oil pump 25.

As shown in FIG. 1 of the description, the rotor output shaft 5 is arranged on the bearing of the motor housing 28 and is connected with the first inner gear ring 23.

As shown in FIG. 1 of the description, the first planet carrier 8 is connected with the second inner gear ring 19.

As shown in FIG. 1 of the description, the second planet carrier 12 is connected with the third inner gear ring 17.

As shown in FIG. 1 of the description, the third planet carrier 15 is connected with the output shaft 16.

As shown in FIG. 1 of the description, the brake B1 24, brake B2 20 and brake B3 18 all are arranged on the drive train housing 29.

As shown in FIG. 1 of the description, the brake B1 24 can stop the rotor output shaft 5 and the first inner gear ring 23.

As shown in FIG. 1 of the description, the brake B2 20 can stop the first planet carrier 8 and the second inner gear ring 19.

As shown in FIG. 1 of the description, the brake B3 18 can stop the second planet carrier 12 and the third inner gear ring 17.

As shown in FIG. 1 of the description, the clutch K1 22 can connect the input shaft 3 and the intermediate drive shaft 9 as a whole.

As shown in FIG. 1 of the description, the intermediate drive shaft 9 is provided with the second sun gear 11 and the third sun gear 14.

As shown in FIG. 1 of the description, the clutch K1 21 can connect the input shaft 3, the second planet carrier 12 and the third inner gear ring 17 as a whole.

The following is the mechanical drive component list 1 of the drive train of the automatic transmission for the electromechanical hybrid vehicle and a drive rule list 2 of three single-row single-stage planetary gear trains connected in series.

Mechanical Drive Component List 1

| | | Clutch | Clutch | Brake | Brake | Brake | |
|---|---|---|---|---|---|---|---|
| Working mode | Gear | K1 22 | K2 21 | B1 24 | B2 20 | B3 18 | One-way clutch 2 |
| Engine drive | 1^{st} gear | Connect | | | | Brake | The flexible |
| mode | 2^{nd} gear | Connect | | | Brake | | coupling 1 drives |
| | 3^{rd} gear | Connect | | Brake | | | the outer ring of the |
| | 4^{th} gear | Connect | Connect | | | | one-way clutch 2, |
| | 5^{th} gear | | Connect | Brake | | | and then the inner |
| | 6^{th} gear | | Connect | | Brake | | ring of the one-way |
| | Reverse gear | | | Brake | | Brake | clutch 2 drives the |
| Hybrid drive | Neutral position | Connect | | | | | input shaft. |
| mode | Forward gear | Connect | | | | | |
| Pure motor | Forward gear | Connect | | Brake | | | The one-way |
| drive mode | Reverse gear | | | Brake | | Brake | clutch 2 slips. |

The following is the drive rule list 2 of three single-row single-stage planetary gear trains connected in series.

| | | | 1^{st} inner | | | 2^{nd} inner | | | 3^{rd} inner | |
|---|---|---|---|---|---|---|---|---|---|---|
| | | 1^{st} sun | gear | 1^{st} plant | 2^{nd} sun | gear | 2^{nd} plant | 3^{rd} sun | gear | 3^{rd} plant |
| | | gear 7 | ring 23 | carrier 8 | gear 11 | ring 19 | carrier 12 | gear 14 | ring 17 | carrier 15 |
| Working | | Number of | Number of | Number of | Number of | Number of | Number of | Number of | Number of | Number of |
| mode | Gear | teeth: 40 | teeth: 80 | teeth: 120 | teeth: 40 | teeth: 80 | teeth: 120 | teeth: 40 | teeth: 80 | teeth: 120 |
| Engine | 1^{st} gear | | | | | | | Actively | Brake | Driven to |
| drive | | | | | | | | rotate 360 | | rotate 120 |
| mode | | | | | | | | degrees | | degrees |
| | | | | | | | | clockwise | | clockwise |
| | 2^{nd} gear | | | | Actively | Brake | Driven to | Actively | Actively | Driven to |
| | | | | | rotate 360 | | rotate 120 | rotate 360 | rotate 120 | rotate 200 |
| | | | | | degrees | | degrees | degrees | degrees | degrees |
| | | | | | clockwise | | clockwise | clockwise | clockwise | clockwise |
| | 3^{rd} gear | Actively | Brake | Driven to | Actively | Actively | Driven to | Actively | Actively | Driven to |
| | | rotate 360 | | rotate 120 | rotate 360 | rotate 120 | rotate 200 | rotate 360 | rotate 200 | rotate 260 |
| | | degrees | | degrees | degrees | degrees | degrees | degrees | degrees | degrees |
| | | clockwise | | clockwise | clockwise | clockwise | clockwise | clockwise | clockwise | clockwise |
| | 4^{th} gear | | | | | | | Actively | Actively | Driven to |
| | | | | | | | | rotate 360 | rotate 360 | rotate 360 |
| | | | | | | | | degrees | degrees | degrees |
| | | | | | | | | clockwise | clockwise | clockwise |
| | 5^{th} gear | Actively | Brake | Driven to | Driven to | Actively | Actively | Actively | Actively | Driven to |
| | | rotate 360 | | rotate 120 | rotate 840 | rotate 120 | rotate 360 | rotate 840 | rotate 360 | rotate 520 |
| | | degrees | | degrees | degrees | degrees | degrees | degrees | degrees | degrees |
| | | clockwise | | clockwise | clockwise | clockwise | clockwise | clockwise | clockwise | clockwise |
| | 6^{th} gear | | | | Driven to | Brake | Actively | Actively | Actively | Driven to |
| | | | | | rotate 1080 | | rotate 360 | rotate 1080 | rotate 360 | rotate 600 |
| | | | | | degrees | | degrees | degrees | degrees | degrees |
| | | | | | clockwise | | clockwise | clockwise | clockwise | clockwise |
| | Reverse | Actively | Brake | Driven to | Driven to | Actively | Brake | Actively | Brake | Driven to |
| | gear | rotate 360 | | rotate 120 | rotate 240 | rotate 120 | | rotate 240 | | rotate 80 |
| | | degrees | | degrees | degrees | degrees | | degrees | | degrees |
| | | clockwise | | clockwise | anticlockwise | clockwise | | anticlockwise | | anticlockwise |

The following are the descriptions of the drive rule and drive ratio of the three single-row single-stage planetary gear trains connected in series with the reference of list 2. To facilitate understanding of the drive ratio of the single-stage planetary gear train, providing that the number of teeth of the sun gear is 40 and the number of the teeth of the inner gear ring is 80, the sum of the former two is equal to the number of teeth of the planet carrier, namely 120; if the sun gear actively rotates for one circle to brake the inner gear ring, the planet carrier is driven by ⅓; and if the inner gear ring actively rotates for one circle to brake the sun gear, the planet carrier is driven by ⅔.

The transmission process of the first gear is as follows: the third sun gear 14 actively rotates 360 degrees clockwise to brake the third inner gear ring 17; then the third planet carrier 15 is driven to rotate 120 degrees clockwise, wherein the drive ratio is 3:1.

The transmission process of the second gear is as follows: the second sun gear 11 actively rotates 360 degrees clockwise to brake the second inner gear ring 19; then the second planet carrier 12 is driven to rotate 120 degrees clockwise and transmits the power to the third inner gear ring 17; then the third inner gear ring 17 actively rotates 120 degrees; the third sun gear 14 actively rotates 360 degrees clockwise; and the third planet carrier 15 is driven to rotate 200 degrees clockwise, wherein the drive ratio is 1.8:1.

The transmission process of the third gear is as follows: the first sun gear 7 actively rotates 360 degrees clockwise to brake the first inner gear ring 23; then the first planet carrier 8 is driven to rotate 120 degrees clockwise and transmits the power to the second inner gear ring 19; then the second inner gear ring 19 actively rotates 120 degrees clockwise; the second sun gear 11 actively rotates 360 degrees clockwise; then the second planet carrier 12 is driven by 200 degrees clockwise and transmits the power to the third inner gear ring 17; then the third inner gear ring 17 actively rotates 200 degrees clockwise; the third sun gear 14 actively rotates 360 degrees clockwise, and then the third planet carrier 15 is driven to rotate 260 degrees clockwise, wherein the drive ratio is 1.38:1.

The transmission process of the fourth gear is as follows: the third sun gear 14 actively rotates 360 degrees clockwise; the third inner gear ring 17 actively rotates 360 degrees clockwise; and the third planet carrier 15 is driven to rotate 360 degrees clockwise, wherein the drive ratio is 1:1.

The transmission process of the fifth gear is as follows: the first sun gear 7 actively rotates 360 degrees clockwise to brake the first inner gear ring 23; then the first planet carrier 8 is driven to rotate 120 degrees clockwise and transmits the power to the second inner gear ring 19; then the second inner gear ring 19 actively rotates 120 degrees clockwise; the second planet carrier 12 actively rotates 360 degrees clockwise; then the second sun gear 11 is driven 840 degrees clockwise and transmits the power to the third sun gear 14; then the third sun gear 14 actively rotates 840 degrees; the third inner gear ring 17 actively rotates 360 degrees clockwise, and then the third planet carrier 15 is driven to rotate 520 degrees clockwise, wherein the drive ratio is 0.69:1.

The transmission process of the sixth gear is as follows: if the second inner gear ring 19 is stopped, the second planet carrier 12 actively rotates 360 degrees clockwise; the second sun gear 11 actively rotates 1,080 degrees clockwise and transmits the power to the third sun gear 14; the third sun gear 14 actively rotates 1,080 degrees clockwise; the third inner gear ring 17 actively rotates 360 degrees, and the third planet carrier 15 is driven to rotate 600 degrees clockwise, wherein the drive ratio is 0.60:1.

The transmission process of the reverse gear is as follows: when the first sun gear 7 actively rotates 360 degrees clockwise, if the first inner gear ring 23 is stopped, the first planet carrier 8 is driven to rotate 120 degrees clockwise and transmits the power to the second inner gear ring 19, and the second inner gear ring 19 actively rotates 120 degrees clockwise; if the second planet carrier 12 is stopped, the second sun gear 11 is driven to rotate 240 degrees anticlockwise and transmits the power to the third sun gear 14, and the third sun gear 14 actively rotates 240 degrees anticlockwise; if the third inner gear ring 17 is stopped, the third planet carrier 15 is driven to rotate 80 degrees anticlockwise, wherein the drive ratio is 4.5:1.

The power transmission routes of the 6 forward gears in the engine drive mode are described in detail by eight steps with the reference of the attached drawings.

The power transmission route of the first gear in the engine drive mode is described in detail with the reference of the FIG. 2:

Step 1, startup process of the vehicle: When a driver rotates a key to start the engine, the fly wheel of the engine idly rotates clockwise and transmits the power to the flexible coupling 1; the flexible coupling 1 transmits the power to the one-way clutch 2; the one-way clutch 2 transmits the power to the input shaft 3; and the input shaft 3 has the following two power transmission routes: 1, the input shaft 3 transmits the power to the motor housing 28, followed by the oil pump input shaft 26 and the oil pump 25; 2, the input shaft 3 transmits the power to the first sun gear 7, the clutch K1 22 and the clutch K2 21, all rotating clockwise.

Step 2, idling process of the vehicle: When the driver shifts to the forward gear in the engine drive mode, the hydraulic system under the control of the automatic transmission computer pushes the clutch K1 22 to connect the intermediate drive shaft 9 by oil pressure; then the intermediate drive shaft 9 rotates clockwise and transmits the power to the second sun gear 11 and the third sun gear 14; the third sun gear 14 rotates clockwise and transmits the power to the third planet gear 13; the third planet gear 13 rotates anticlockwise and transmits the power to the third inner gear ring 17; the third inner gear ring 17 rotates anticlockwise and transmits the power to the second planet carrier 12; the second planet carrier 12 drives the second planet gear to rotate anticlockwise around the second sun gear 11 and transmit the power to the second inner gear ring 19; the second inner gear ring 19 rotates anticlockwise and transmits the power to the first planet carrier 8; the first planet carrier 8 rotates anticlockwise and transmits the power to the first planet gear 6; the first planet gear 6 rotates anticlockwise around the first sun gear 7 and transmits the power to the first inner gear ring 23; the first inner gear ring 23 rotates anticlockwise and transmits the power to the rotor output shaft 5; the rotor output shaft 5 rotates anticlockwise; and thus, the vehicle is shifted to the neutral position.

Step 3, startup process of the vehicle: When the driver releases the hand brake and steps on the pedal, the hydraulic system under the control of the automatic transmission computer pushes the brake B3 18 via the hydraulic oil to slowly stop the anticlockwise rotation of the third inner gear ring 17 and the second planet carrier 12; the third sun gear 14 rotates clockwise and transmits the third planet gear 13, so the third planet gear 13 rotates anticlockwise in the third inner gear ring 17 and transmits the power to the third planet carrier 15; then the third planet carrier 15 rotates clockwise and transmits the power to the output shaft 16; the output shaft 16 rotates anticlockwise and outputs power; and thus, the power transmission route of the first gear is set up.

The following is the electricity generation process of the vehicle during running: When the power transmission route of the first gear is set up, the second sun gear 11 rotates clockwise and transmits the power to the second planet gear 10, so the second planet gear 10 rotates anticlockwise and transmits the power to the second inner gear ring 19; the second inner gear ring 19 rotates anticlockwise and transmits the power to the first planet carrier 8; and the first planet carrier 8 rotates anticlockwise and transmits the power to the first planet gear 6. Meanwhile, the first sun gear 7 rotates clockwise and transmits the power to the first planet carrier 6, so the first planet gear 6 rotates anticlockwise and transmits the power to the first inner gear ring 23; then the first inner gear ring 23 rotates anticlockwise and transmits the power to the rotor output shaft 5; because the rotor output shaft 5 rotates anticlockwise and the motor stator 27 rotates clockwise along with the input shaft 3, the motor stator 27 can generate electricity as long as the rotor output shaft 5 generates an electromagnetic field; and when the motor stator 27 rotates clockwise to generate electricity and generates an acting force to enable the rotor shaft 5 to rotate clockwise via the electromagnetic field; and this acting force is the reacting force onto the rotor output shaft 5 during electricity generation.

When the speed of the vehicle rises gradually after starting, the automatic transmission computer can judge the running speed and running resistance of the vehicle and the reacting force of the rotor output shaft 5 during the electricity generation via a sensor; when the automatic transmission computer judges that the reacting force of the rotor output shaft 5 during the electricity generation is bigger than the running resistance of the vehicle, the hydraulic system under the control of the automatic transmission computer releases the oil pressure of the brake B3 18; and then the brake B3 18 releases the third inner gear ring 17 and the second planet carrier 12 such that the reacting force generated by the rotor output shaft 5 replaces the braking resistance of the brake B3 18. Analysis of the above mentioned transmission process finds that two kinds of resistances exist: one comes from the reacting force of the rotor output shaft 5 during the electricity generation, and the other comes from the output shaft 16, which is the running resistance of the vehicle. The second sun gear 11 rotates clockwise and transmits the power to the second planet gear 10, so the second planet gear 10 rotates anticlockwise and transmits the power to the second inner gear ring 21 and the second planet carrier 12; and the second planet gear 10 can balance the two kinds of resistances such that the vehicle generates electricity during running and avoids wasting the power of the engine.

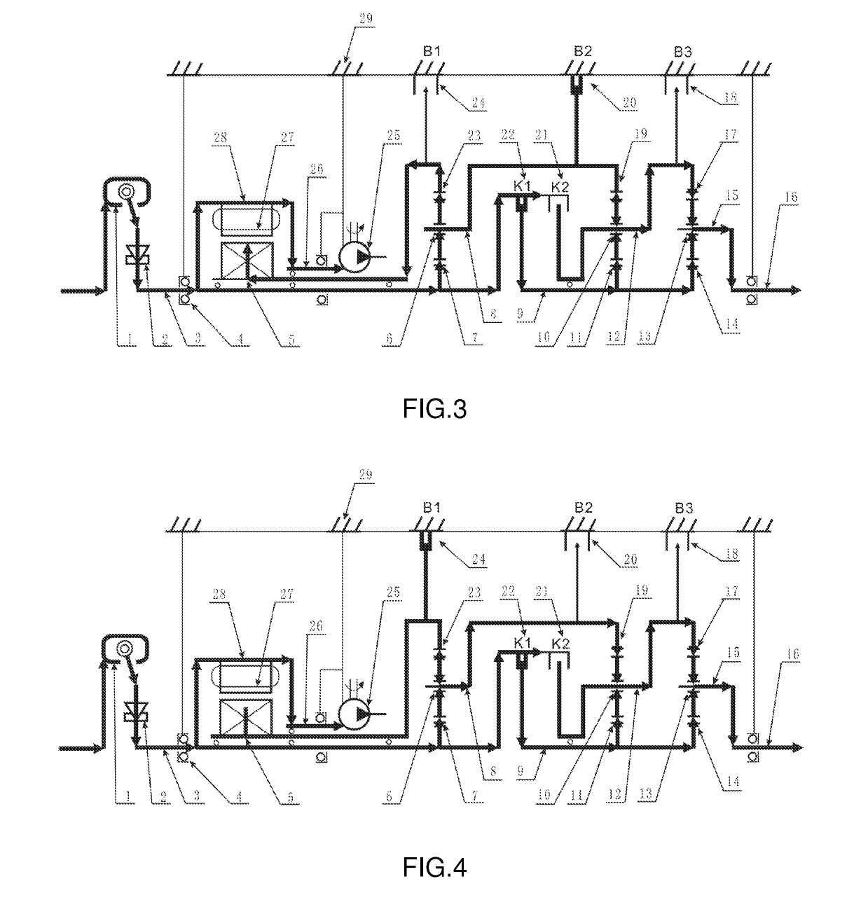

The power transmission route of the second gear in the engine drive mode is described in detail with the reference of FIG. 3: Step 4, when the driver steps on the accelerator pedal, the speed of the vehicle rises; when the automatic transmission computer judges that the speed of the vehicle reaches second gear and that the electricity generation resistance of the output shaft 5 is smaller than the running resistance of the vehicle, the hydraulic system under the control of the automatic transmission computer controls the oil pressure to push the brake B2 20 to slowly brake the second inner gear ring 19 and the first planet carrier 8 such that the braking resistance of the brake B2 20 replaces the electricity generation resistance of the rotor output shaft 5; the second sun gear 11 rotates clockwise and transmits power to the second planet gear 10, so the second planet gear 10 rotates anticlockwise in the second inner gear ring 19 and transmits the power to the second planet carrier 12; then the second planet carrier 12 rotates clockwise and transmits the power to the third inner gear ring 17; and the third inner gear ring 17 rotates clockwise and transmits the power to the third planet gear 13. Analysis of the above transmission process shows that: the third sun gear 14 has already rotated clockwise at the first gear; when entering the second gear, the third inner gear ring 17 starts to rotate clockwise, so the rotation speed entering the second gear is the sum of the rotation speed of the third sun gear 14 and the rotation speed of the third inner gear ring 17, which commonly drives the third planet gear 13 such that the third planet gear 13 can balance the two kinds of driving forces and transmit the power to the third planet carrier 15; then the third planet carrier 15 rotates clockwise and transmits the power to the output shaft 16; and the output shaft 16 rotates clockwise and outputs the power. Thus, the power transmission route of the second gear is set up.

When the power transmission route of the second gear is set up, the first sun gear 7 rotates clockwise and transmits the power to the first planet gear 6; the first planet gear 6 rotates anticlockwise and transmits the power to the first inner gear ring 23; and the first inner gear ring 23 rotates anticlockwise and transmits the power to the rotor output shaft 5. Due to the anticlockwise rotation of the rotor output shaft 5 and the clockwise rotation of the motor stator 27 along with the input shaft 3, the motor stator 27 can generate electricity as long as the rotor output shaft 5 generates an electromagnetic field. When the motor stator 27 rotates clockwise to generate electricity and generates an acting force onto the rotor output shaft 5 for clockwise rotation, the acting force is the reacting force of the rotor output shaft 5 during electricity generation.

When the vehicle is speeding up gradually, the automatic transmission computer can judge the running speed and running resistance of the vehicle and judge the reacting force of the rotor output shaft 5 during electricity generation via the sensor; when the automatic transmission computer judges that that the reacting force of the rotor output shaft 5 during electricity generation is bigger than the running resistance of the vehicle, the hydraulic system under the control of the automatic transmission computer releases the oil pressure of the brake B2 20; then the brake B2 20 releases the second inner gear ring 19 and the first planet carrier 8 such that the reacting force of the rotor output shaft 5 during electricity generation replaces the braking resistance of the brake B2 20. Analysis of the above transmission process shows that: the brake B2 20 stops the second inner gear ring 19 and the first planet carrier 8 is to stop the anticlockwise rotation thereof such that the power transmission route of the second gear is set up. When the reacting force of the rotor output shaft 5 during electricity generation is bigger than the running resistance of the vehicle, the reacting force of the rotor output shaft 5 during electricity generation can be used for replacing the braking resistance of the brake B2 20 and pushing the first planet carrier 8 and the second inner gear ring 19 to rotate clockwise.

The power transmission route of the third gear in the engine drive mode is described in detail with the reference of FIG. 4: Step 5, when the driver continuously steps on the accelerator pedal, the vehicle is speeding up continuously; when the automatic transmission computer judges that the vehicle speed reaches the third gear and that the resistance of the rotor output shaft 5 during electricity generation is smaller than the running resistance of the vehicle, the hydraulic system under the control of the automatic transmission computer controls the oil pressure to push the brake B1 24 to slowly brake the first inner gear ring 23 and the rotor output shaft 5. The first sun gear 7 rotates clockwise and transmits the power to the first planet carrier 6, so the first planet carrier 6 rotates anticlockwise in the first gear ring 23 and transmits the power to the first planet carrier 8; the first planet carrier 8 rotates clockwise and transmits the power to the second inner gear ring 19; and the second inner gear ring 19 rotates clockwise and transmits the power to the second planet gear 10. The analysis of the above power transmission process shows that: the rotation of the second inner gear ring 19 and the rotation of the second sun gear 11 together drive the second planet gear 10 which can balance the two kinds of driving forces and transmit the power to the second planet carrier 12; then the second planet carrier 12 rotates clockwise and transmits the power to the third inner gear ring 17; the rotation of the third inner gear ring 17 and the rotation of the third sun gear 14 together drive the third planet gear 13 which can balance the two kinds of driving forces and transmit the power to the third planet carrier 15; then the third planet carrier 15 rotates clockwise and transmits the power to the output shaft 16; and the output shaft 16 rotates clockwise and outputs the power. Thus, the power transmission route of the third gear is set up.

When the power transmission route of the third gear is set up, the brake B1 24 stops the first inner gear ring 23 and the rotor output shaft 5. The motor stator 27 is arranged on the motor housing 28 and the motor housing 28 is arranged on the input shaft 3, so the rotation of the input shaft 3 is equal to the rotation of the motor stator 27, and the motor stator 27 can generate electricity as long as the output shaft 5 generates the electromagnetic field.

When the vehicle is speeding up gradually, the automatic transmission computer can judge the running speed and running resistance of the vehicle and judge the resistance of the motor stator 27 during electricity generation via the sensor; when the automatic transmission computer judges that that the resistance of the motor stator 27 during electricity generation is bigger than the running resistance of the vehicle, the hydraulic system under the control of the automatic transmission computer releases the oil pressure of the brake B1 24; then the brake B1 24 releases the first inner gear ring 23 and the rotor output shaft 5 such that the reacting force of the rotor output shaft 5 during electricity generation replaces the braking resistance of the brake B1 24. Analysis of the above transmission process shows that: the brake B1 24 stops the first inner gear ring 23 and the first planet carrier 5 is to stop the anticlockwise rotation thereof such that the power transmission route of the third gear is set up. When the reacting force of the rotor output shaft 5 during electricity generation is bigger than the running resistance of the vehicle, the reacting force of the rotor output shaft 5 during electricity generation can be used for replacing the braking resistance of the brake B1 24 and pushing the first inner gear ring 23 to rotate clockwise.

The power transmission route of the fourth gear in the engine drive mode is described in detail with the reference of the FIG. 5: Step 6, when the driver continuously steps on the accelerator pedal, the vehicle is speeding up gradually; when the automatic transmission computer judges that the vehicle speed reaches fourth gear, the hydraulic system under the control of the automatic transmission computer controls the oil pressure to push the clutch K2 21 to slowly connect the second planet carrier 12 such that the second planet carrier 12 is turned from a driven component into a driving component and actively transmits the power to the third inner gear ring 17. Analysis of the above power transmission process shows that: the clutch K1 22 drives the third sun gear 14, while the clutch K2 21 starts up the drive of the third inner gear ring 17; the third sun gear 14 and the third inner gear ring 17 are identical in the rotation direction and rotation speed and commonly drive the third planet gear 13; then the third planet gear 13 transmits the power to the third planet carrier 15; next, the third planet carrier 15 rotates clockwise and transmits the power to the output shaft 16; and finally the output shaft 16 rotates clockwise and outputs the power. Thus, the power transmission route of the fourth gear is set up.

When the power transmission route of the fourth gear is set up, the whole variable speed drive train is identical in direction and speed, which means that the motor stator 27 and the rotor output shaft 5 are also identical in direction and speed, so electricity generation fails.

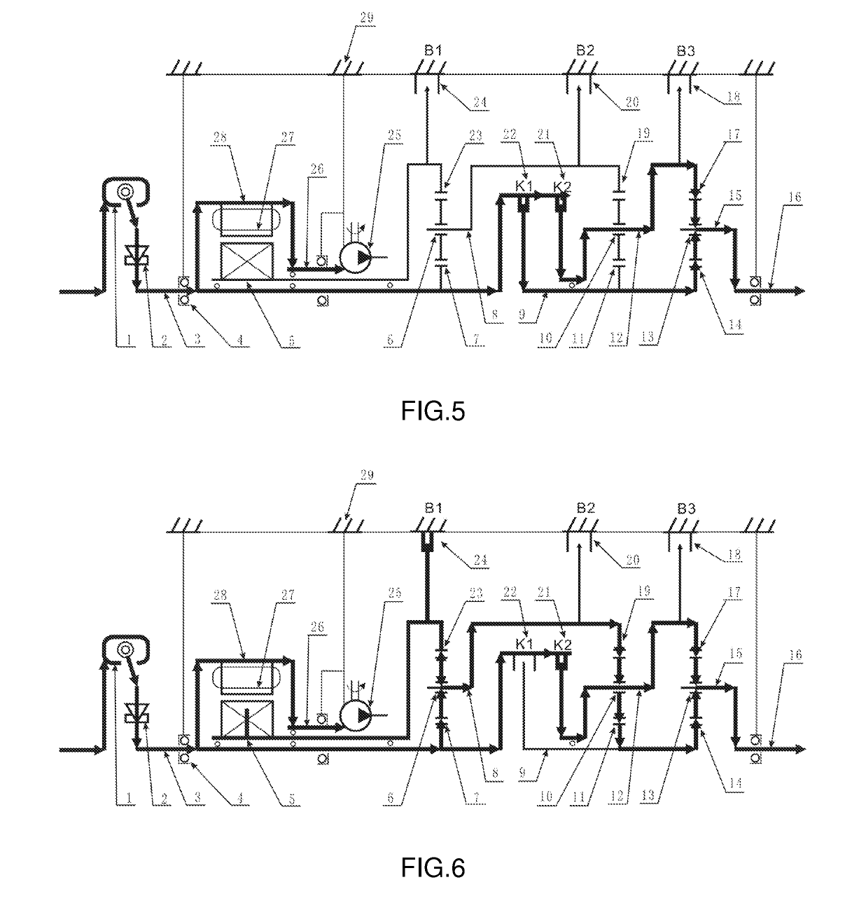

The power transmission route of the fifth gear in the engine drive mode is described in detail with the reference of the FIG. 6: Step 7, when the driver continuously steps on the accelerator pedal, the vehicle is speeding up continuously; when the automatic transmission computer judges that the vehicle speed reaches fifth gear, the hydraulic system under the control of the automatic transmission computer slowly brakes the oil pressure of the clutch K1 22 such that the clutch K1 22 releases the intermediate drive shaft 9 in connection; meanwhile the hydraulic system controls the oil pressure to push the brake B1 24 to slowly stop the first inner gear ring 23, so two power transmission routes are produced. The following is the first power transmission route: The brake B1 24 slowly stops the first inner gear ring 23 and the first sun gear 7 rotates clockwise and transmits the power to the first planet gear 6, so the first sun gear 6 rotates anticlockwise in the first inner gear ring 23 and transmits the power to the first planet carrier 8; next, the first planet carrier 8 rotates clockwise and transmits the power to the second inner gear ring 19; and then the second inner gear ring 19 rotates clockwise and transmits the power to the second planet gear 10. The second power transmission route is as follows: the second planet carrier 12 continuously rotates clockwise and transmits the power to the second planet gear 10 and the third inner gear ring 17, so two kinds of driving forces are applied onto the second planet gear 10; the two kinds of driving forces generate different rotation speeds, wherein the first driving force enables the second inner gear ring 19 to rotate clockwise in a decelerated way and transmit the power to the second planet gear 10, while the second driving force enables the second planet carrier 12 to directly rotate clockwise and transmit the power to the second planet gear 10; the clockwise rotation of the second inner gear ring 19 is slow and the clockwise rotation of the second planet carrier 12 is fast, so the second planet gear 10 rotates anticlockwise and transmits the power to the second sun gear 11; then the second sun gear 11 rotates clockwise and transmits the power to the third sun gear 14; next, the third sun gear 14 rotates clockwise and transmits the power to the third sun gear 13; meanwhile, the third inner gear ring 17 transmits the power to the third planet gear 13 which can balance the two kinds of driving forces and transmit the power to the third planet carrier 15; then the third planet carrier 15 rotates clockwise and transmits the power to the output shaft 16; and the output shaft 16 rotates clockwise and outputs the power. Thus, the power transmission route of the fifth gear is set up.

When the power transmission route of the fifth gear is set up, the brake B1 24 brakes the first inner gear ring 23 and the rotor output shaft 5. The motor stator 27 is arranged on the motor housing 28 and the motor housing 28 is arranged on the input shaft 3, so the rotation of the input shaft 3 is equal to the rotation of the motor stator 27, and the motor stator 27 can generate electricity as long as the output shaft 5 generates the electromagnetic field.

When the vehicle is speeding up gradually, the automatic transmission computer can judge the running speed and running resistance of the vehicle and judge the resistance of the motor stator 27 during electricity generation via the sensor; when the automatic transmission computer judges that that the resistance of the motor stator 27 during electricity generation is bigger than the running resistance of the vehicle, the hydraulic system under the control of the automatic transmission computer releases the oil pressure of the brake B1 24; then the brake B1 24 releases the first inner gear ring 23 and the rotor output shaft 5 such that the reacting force of the rotor output shaft 5 during electricity generation replaces the braking resistance of the brake B1 24. Analysis of the above transmission process shows that: the brake B1 24 stops the first inner gear ring 23 and the first planet carrier 5 is to stop the anticlockwise rotation thereof such that the power transmission route of the fifth gear is set up. When the reacting force of the rotor output shaft 5 during electricity generation is bigger than the running resistance of the vehicle, the reacting force of the rotor output shaft 5 during electricity generation can be used for replacing the braking resistance of the brake B1 24 and pushing the first inner gear ring 23 to rotate clockwise.

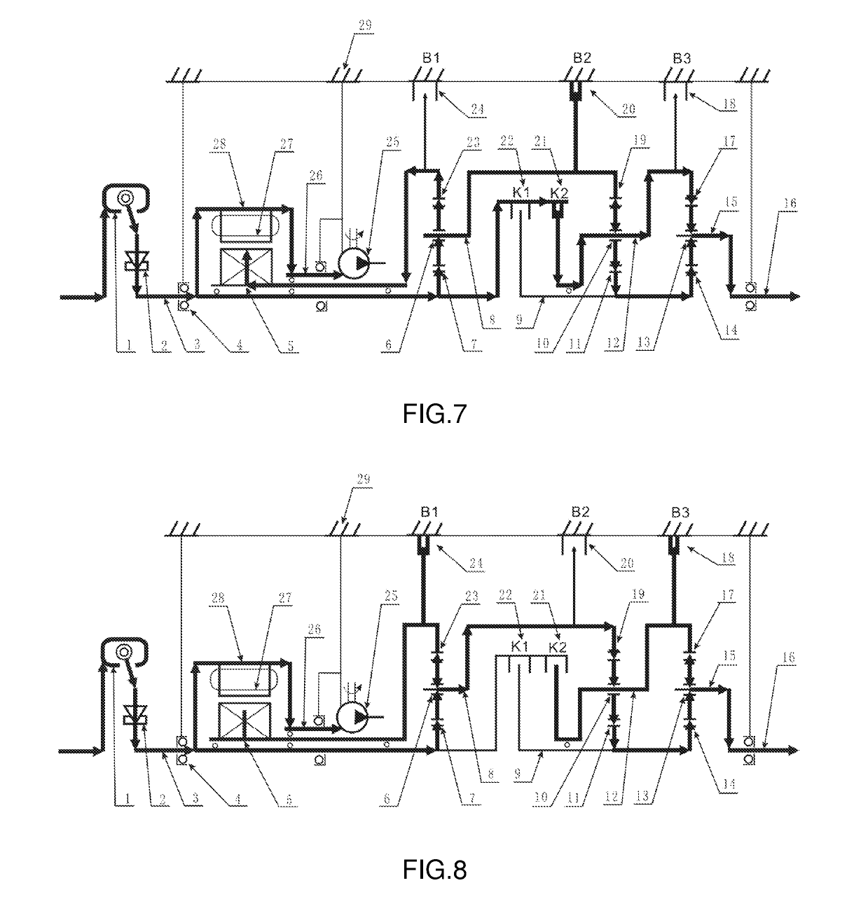

The power transmission route of the sixth gear in the engine drive mode is described in detail with the reference of FIG. 7: Step 8, when the driver continuously steps on the accelerator pedal, the vehicle is speeding up continuously; when the automatic transmission computer judges that the vehicle speed reaches the sixth gear and that the resistance of the rotor output shaft 5 during electricity generation is smaller than the running resistance of the vehicle, the hydraulic system under the control of the automatic transmission computer controls the oil pressure to push the brake B2 20 to slowly brake the second inner gear ring 19 and the first planet carrier 8. The second planet carrier 12 rotates clockwise and transmits the power to the second planet gear 10, so the second planet gear 10 rotates anticlockwise in the second gear ring 19 and transmits the power to the second sun gear 11; then the second sun gear 11 rotates clockwise and transmits the power to the third sun gear 14; and the third sun gear 14 rotates clockwise in an accelerated way and transmits the power to the third planet carrier 13. Analysis of the above power transmission process shows that: two driving forces are applied onto the third planet gear 13, wherein the first one comes from the situation that the second planet carrier 12 rotates clockwise and transmits the power to the third inner gear ring 17 and then the third inner gear ring 17 rotates clockwise and transmits the power to the third planet gear 13; and the second one comes from the third sun gear 14; the third planet gear 13 can balance the two kinds of driving forces and transmits the power to the third planet carrier 15; then the third planet carrier 15 rotates clockwise and transmits the power to the output shaft 16; and finally the output shaft 16 rotates clockwise and output the power. Thus, the power transmission route of the sixth gear is set up.

When the power transmission route of the sixth gear is set up, the first sun gear 7 rotates clockwise and transmits the power to the first planet gear 6, so the first planet gear 6 rotates anticlockwise and transmits the power to the first inner gear ring 23; and the first inner gear ring 23 rotates anticlockwise and transmits the power to the rotor output shaft 5. Due to the anticlockwise rotation of the rotor output shaft 5 and the clockwise rotation of the motor stator 27 along with the input shaft 3, the motor stator 27 can generate electricity as long as the rotor output shaft 5 generates an electromagnetic field. When the motor stator 27 rotates clockwise to generate electricity and applies an acting force to enable the rotor output shaft 5 to rotate clockwise by the electromagnetic field, wherein the acting force is the reacting force of the rotor output shaft 5 during electricity generation.

When the vehicle is speeding up gradually, the automatic transmission computer can judge the running speed and running resistance of the vehicle and judge the reacting force of the rotor output shaft 5 during electricity generation via the sensor; when the automatic transmission computer judges that that the reacting force of the rotor output shaft 5 during electricity generation is bigger than the running resistance of the vehicle, the hydraulic system under the control of the automatic transmission computer releases the oil pressure of the brake B2 20; then the brake B2 20 releases the second inner gear ring 19 and the first planet carrier 8 such that the reacting force of the rotor output shaft 5 during electricity generation replaces the braking resistance of the brake B2 20. Analysis of the above transmission process shows that: the brake B2 20 stops the second inner gear ring 19 and the first planet carrier 8 is to stop the anticlockwise rotation thereof such that the power transmission route of the sixth gear is set up. When the reacting force of the rotor output shaft 5 during electricity generation is bigger than the running resistance of the vehicle, the reacting force of the rotor output shaft 5 during electricity generation can be used for replacing the braking resistance of the brake B2 20 and pushing the second inner gear ring 19 and the first planet carrier 8 to rotate clockwise. Thus, the drive ratio of an ultrahigh speed above the sixth gear is obtained.

If the driver suddenly releases the accelerator pedal during running, the rotation speed of the engine will decline quickly; due to the inertia in motion of the vehicle, the power is transmitted back to the drive train of the automatic transmission from the wheels. In the present invention, the drive train of the automatic transmission for the electromechanical hybrid vehicle is provided with the one-way clutch 2 inside, and when the power is transmitted back from the wheels of the vehicle, the one-way clutch 2 slips such that the aim of energy conservation can be realized by fully utilizing the inertia in motion of the vehicle and the slipping.

The power transmission route of the reverse gear in the engine drive mode is described in detail by three steps with the reference of the FIG. 8: Step 1, startup process of the vehicle: When the driver turns the key to start the engine, the fly wheel of the engine idly rotates clockwise and transmits the power to the flexible coupling 1; next, the flexible coupling 1 transmits the power to the one-way clutch 2; then the one-way clutch 2 transmits the power to the input shaft 3, wherein the input shaft 3 has two transmission routes: 1, the input shaft 3 transmits the power to the motor housing 28; then the motor housing 28 transmits the power to the oil pump input shaft 26; and finally the oil pump input shaft 26 transmits the power to the oil pump 25; 2, the input shaft 3 transmits the power to the first sun gear 7 and rotates clockwise.

Step 2, the idling process of the vehicle: when the driver shifts the gear to the reverse gear in the engine drive mode, the hydraulic system under the control of the automatic transmission computer pushes the brake B3 18 to brake the third inner gear ring 17 and the second planet carrier 12. The first sun gear 7 rotates clockwise and transmits the power to the first planet gear 6, so the first planet gear 6 rotates anticlockwise and transmits the power to the first inner gear ring 23; next, the first inner gear ring 23 rotates anticlockwise and transmits the power to the rotor output shaft 5; and then the rotor output shaft 5 rotates anticlockwise, wherein the power cannot be transmitted to the output shaft 16 at this moment.

Step 3, startup process of the vehicle: when the driver releases the hand brake and steps on the accelerator pedal, the hydraulic system under the control of the automatic transmission computer pushes the brake B1 24 to slowly stop the anticlockwise rotation of the first inner gear ring 23 and the rotor output shaft 5 via the oil pressure.; the first sun gear 7 rotates clockwise and transmits the power to the first planet gear 6, so the first planet gear 6 rotates anticlockwise in the first inner gear ring 23 and transmits the power to the first planet carrier 8; next, the first planet carrier 8 rotates clockwise and transmits the power to the second inner gear 19; then the second inner gear ring 19 rotates clockwise and transmits the power to the second planet gear 10; the brake B3 18 brakes the second planet carrier 12 and the third inner gear ring 17, so the second planet gear 10 rotates clockwise on the second planet carrier 12 and transmits the power to the second sun gear 11; the second sun gear 11 rotates anticlockwise and transmits the power to the third sun gear 14; the third sun gear 14 rotates clockwise and transmits the power to the third planet gear 13; the third planet gear 13 rotates clockwise in the third inner gear ring 17 and transmits the power to the third planet carrier 15; subsequently, the third planet carrier 15 rotates anticlockwise and transmits the power to the output shaft 16; and the output shaft 16 rotates anticlockwise and output the power. Thus, the power transmission route of the reverse gear in the engine drive mode is set up.

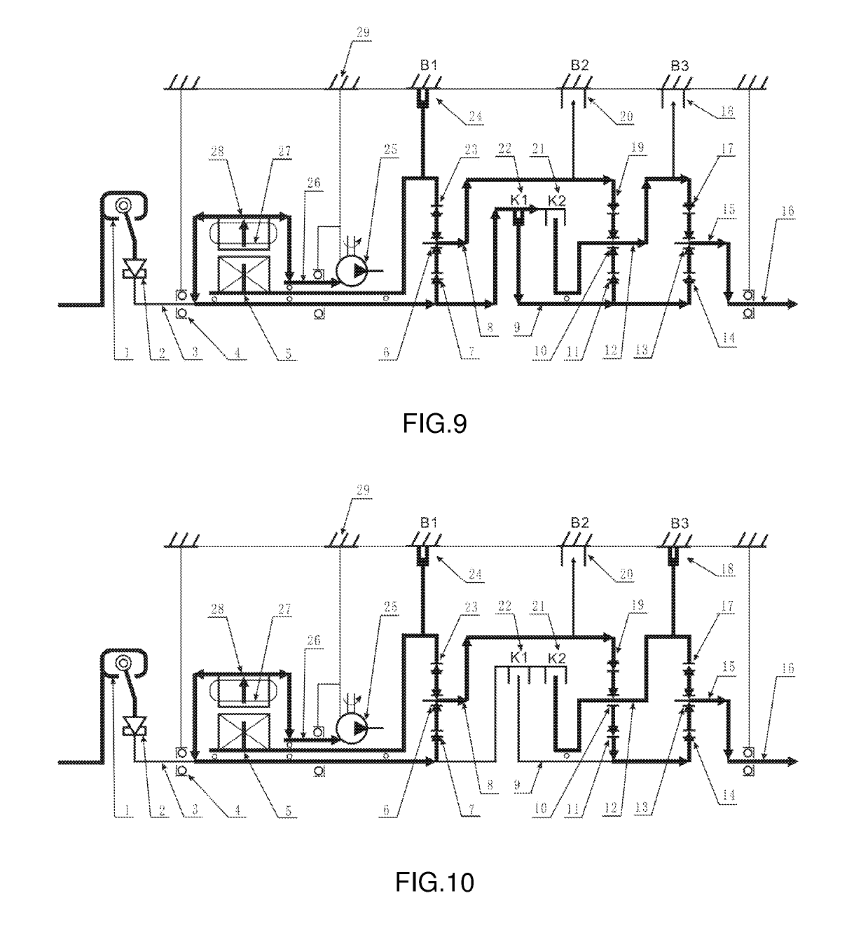

The power transmission route of the forward gear in the pure motor drive mode is described in detail by three steps with the reference of the FIG. 9: Step 1, when the driver turns the key to start the circuit control system of the vehicle and shift the gear to the forward gear in the pure motor drive mode, the hydraulic system under the control of the automatic transmission computer pushes the brake B1 24 to stop the first inner gear ring 23 and the rotor output shaft 5 and pushes the clutch K1 22 to connect the intermediate drive shaft 9 via the oil pressure because the circuit system and the hydraulic system are respectively provided with a small motor and drive a small oil pump and the small motor drives the small oil pump to work at the same time. Thus, the input shaft 3 is connected with the second sun gear 11 and the third sun gear 14 on the intermediate drive shaft 9 as a whole.

Step 2, when the driver releases the handle brake and steps on the accelerator pedal, the circuit control system under the control of the automatic transmission computer supplies power to the motor 27 via a frequency converter; the brake B1 24 brakes the first inner gear ring 23 and the rotor output shaft 5, so the motor stator 27 rotates clockwise and generates the following two power transmission routes: 1, the motor stator 27 transmits the power to the motor housing 28, followed by the oil pump input shaft 26 and the oil pump 25; 2, the motor stator 27 transmits the power to the motor housing 28, followed by the input shaft 3, the first sun gear 7, the second sun gear 11 and the third sun gear 14, and the input shaft 3 rotates clockwise, meanwhile the one-way clutch 2 connected with the front end of the input shaft 3 slips.

The first sun gear 7 rotates clockwise and the transmits the power to the first sun gear 6, so the first planet gear 6 rotates anticlockwise in the first inner gear ring 23 and transmits the power to the first planet carrier 8; then the first planet carrier 8 rotates clockwise and transmits the power to the second inner gear ring 19; and the second inner gear ring 19 rotates clockwise and transmits the power to the second planet gear 10. The second sun gear 11 rotates clockwise and transmits the power to the second planet gear 10, so analysis of the above transmission process shows that: the rotation of the second inner gear ring 19 and the rotation of the second sun gear 11 together drive the second planet gear 10 which can balance the two kinds of driving forces and transmits the power to the second planet carrier 12; the second planet carrier 12 rotates clockwise and transmits the power to the third inner gear ring 17; the rotation of the third inner gear ring 17 and the rotation of the third sun gear 14 together drive the third planet gear 13 which can balance the two kinds of driving forces and transmits the power to the third planet carrier 15; then the third planet carrier 15 rotates clockwise and transmits the power to the output shaft 16; and finally the output shafts rotates clockwise and outputs the power. Thus, the power transmission route of the forward gear in the pure motor drive mode is set up.

Step 3, when the driver slowly floors the accelerator pedal, the frequency converter under the control of the automatic transmission computer supplies a small current to the motor stator 27, so the motor stator 27 outputs a small torque; when the driver quickly floors the accelerator pedal, the frequency converter under the control of the automatic transmission computer supplies a large current to the motor stator 27, so the motor stator 27 outputs a large torque. Thus, the driver can control the vehicle speed of the forward gear by controlling the speed of flooring the accelerator pedal.

The power transmission route of the reverse gear in the pure motor drive mode is described in detail by three steps with the reference of the FIG. 10: Step 1, when the driver turns the key to start the circuit control system of the vehicle and shift the gear to the reverse gear in the pure motor drive mode, the hydraulic system under the control of the automatic transmission computer pushes the brake B1 24 to brake the first inner gear ring 23 and the rotor output shaft 5 and pushes the brake B3 18 to brake the third inner gear ring 17 and the second planet carrier 12 by oil pressure because the circuit system and the hydraulic system are respectively provided with a small motor and drive a small oil pump and the small motor drives the small oil pump to work at the same time.

Step 2, when the driver releases the hand brake and steps on the accelerator pedal, the circuit control system under the control of the automatic transmission computer supplies power to the motor 27 via the frequency converter; the brake B1 24 stops the first inner gear ring 23 and the rotor output shaft 5, so the motor stator 27 rotates clockwise and generates two power transmission routes: 1, the motor stator 27 transmits the power to the motor housing 28, followed by the oil pump input shaft 26 and the oil pump 25; 2, the motor stator 27 transmits the power to the motor housing 28, followed by the input shaft 3 and the first sun gear 7, and the input shaft 3 rotates clockwise, meanwhile the one-way clutch 2 connected with the front end of the input shaft 3 slips.

The first sun gear 7 rotates clockwise and transmits power to the first planet gear 6, so the first planet gear 6 rotates anticlockwise in the first inner gear ring 23 and transmits the power to the first planet carrier 8; then the first planet carrier 8 rotates clockwise and transmits the power to the second inner gear ring 19; the second inner gear ring 19 rotates clockwise and transmits the power to the second planet gear 10; the brake B3 18 brakes the third inner gear ring 17 and the second planet carrier 12, so the second planet gear 10 rotates clockwise and transmits the power to the second sun gear 11; the second sun gear rotates anticlockwise and transmits the power to the third sun gear 14; the third sun gear 14 rotates anticlockwise and transmits the power to the third planet gear 13; the third planet gear 13 rotates clockwise in the third inner gear ring 17 and transmits the power to the third planet carrier 15; the third planet carrier 15 rotates anticlockwise and transmits the power to the output shaft 16; and finally the output shaft 16 rotates anticlockwise and outputs the power. Thus, the power transmission route of the reverse gear in the pure motor drive mode is set up.

Step 3, when the driver slowly floors the accelerator pedal, the frequency converter under the control of the automatic transmission computer supplies a small current to the motor stator 27, so the motor stator 27 outputs a small torque; when the driver quickly floors the accelerator pedal, the frequency converter under the control of the automatic transmission computer supplies a large current to the motor stator 27, so the motor stator 27 outputs a large torque. Thus, the driver can control the vehicle speed of the forward gear by controlling the speed of flooring the accelerator pedal.

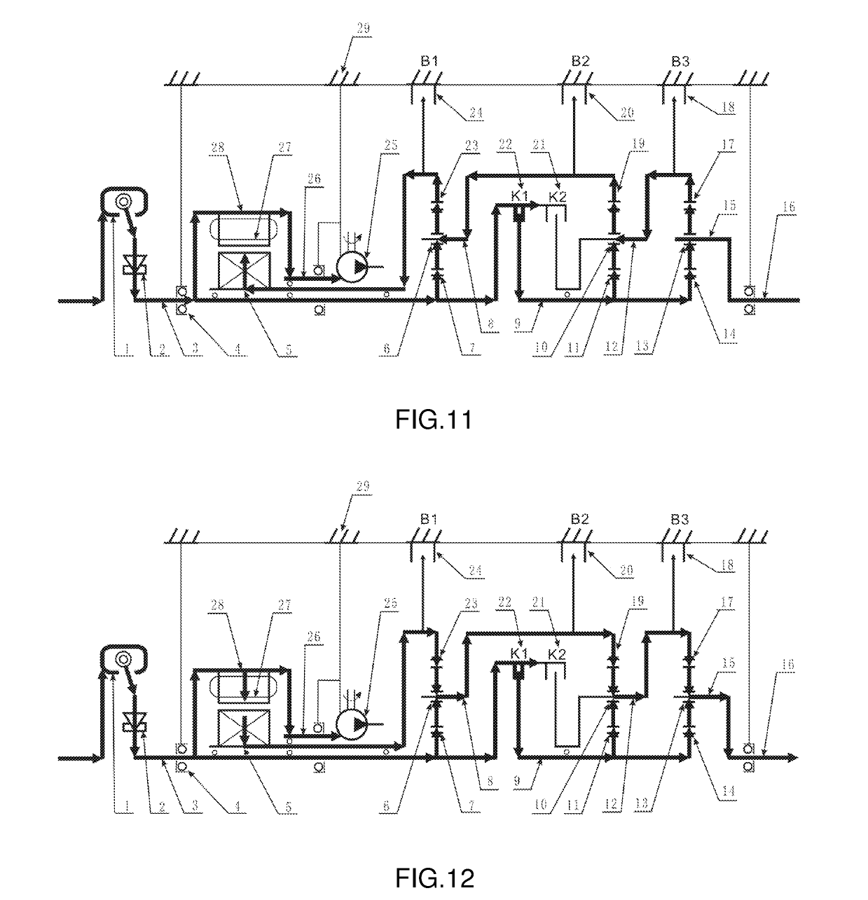

The power transmission route of the neutral position in the hybrid drive mode is described in detail by three steps with the reference of the FIG. 11: Step 1, startup process of the vehicle: When the driver turns the key to start the engine, the fly wheel of the engine idly rotates clockwise and transmits the power to the flexible coupling 1; the flexible coupling 1 transmits the power to the one-way clutch 2; then the one-way clutch 2 transmits the power to the input shaft 3, wherein the input shaft 3 has two transmission routes: 1, the input shaft 3 transmits the power to the motor housing 28, followed by the oil pump input shaft 26 and the oil pump 25; 2, the input shaft 3 transmits the power to the first sun gear 7, the clutch K1 22 and the clutch K2 21, all rotating clockwise.

Step 2, idling process: when the driver shifts the gear to the forward gear in the electromechanical hybrid drive mode, the hydraulic system under the control of the automatic transmission computer pushes the clutch K1 22 to connect the intermediate driver shaft 9 by oil pressure; the intermediate drive shaft 9 rotates clockwise and transmits the power to the second gear 11 and the third sun gear 14; the third sun gear 14 rotates clockwise and transmits the power to the third planet gear 13; the third planet gear 13 rotates anticlockwise and transmits the power to the third inner gear ring 17; the third inner gear ring 17 rotates anticlockwise and transmits the power to the second planet carrier 12; the second planet carrier 12 drives the second planet gear to rotate anticlockwise around the second sun gear 11 and transmits the power to the second inner gear ring 19; the second inner gear ring 19 rotates anticlockwise and transmits the power to the first planet carrier 8; the first planet carrier 8 drives the first planet gear 6 to rotate anticlockwise around the first sun gear 7 and transmits the power to the first inner gear ring 23; then the first inner gear ring 23 rotates anticlockwise and transmits the power to the rotor output shaft 5 to make the rotor output shaft 5 rotate anticlockwise; and thus, the vehicle is shifted to the neutral position.

The power transmission route of the forward stepless speed change in the hybrid drive mode is described in detail by two steps with the reference of the FIG. 12: Step 1, when the driver releases the hand brake and steps on the accelerator pedal, the frequency converter under the control of the automatic transmission computer supplies power to the motor stator 27, then the rotor output shaft 5 rotates clockwise and transmits the power to the first inner gear ring 23; the first inner gear ring 23 rotates clockwise and transmits the power to the first planet gear 6, meanwhile, the first sun gear 7 rotates clockwise and transmits the power to the first planet gear 6 which can balance the driving forces of the two kinds of rotation speeds and transmit the power to the first planet carrier 8; the first planet carrier 8 rotates clockwise and transmits the power to the second inner gear ring 19; the second inner gear ring 19 rotates clockwise and transmits the power to the second planet gear 10, meanwhile the second sun gear 11 rotates clockwise and transmits the power to the second planet gear 10 which can balance the driving forces of the two kinds of rotation speeds and transmit the power to the second planet carrier 12; the second planet carrier 12 rotates clockwise and transmits the power to the third inner gear ring 17; the third inner gear ring 17 rotates clockwise and transmits the power to the third planet gear 13, meanwhile the third sun gear 14 rotates clockwise and transmits the power to the third planet gear 13 which can balance the driving forces of the two kinds of rotation speeds and transmit the power to the third planet carrier 15; then the third planet carrier 15 rotates clockwise and transmits the power to the output shaft 16; and the output shaft 16 rotates clockwise and outputs the power.

Step 2, the driver can control the vehicle speed by controlling the speed of flooring the accelerator pedal; the automatic transmission computer adjusts the rotation speed of the engine and the current of the motor stator 27 at any time according to the vehicle speed and load of the vehicle; when the vehicle runs at a low speed with a heavy load, the rotation of the input shaft 3 and the rotation of the output shaft 5 together drive the vehicle to run; when the vehicle runs at a high speed with a low load, the rotation speed of the rotor output shaft 5 can be higher than that of the input shaft 3, so a big drive ratio can be obtained.

Due to the above hybrid drive mode, the clutch and brake for shifting the gear are not required at the moment of the startup and during the running of the vehicle, so stepless speed change is realized; besides, a large torque can be transmitted. With the above mentioned drive train of the automatic transmission, the drive train of the automatic transmission for the electromechanical hybrid vehicle of the present invention is set up.

What is claimed is:

1. A drive train for an automatic transmission for an electromechanical hybrid vehicle, comprising a flexible coupling (1), a one-way clutch (2), an input shaft (3), a radial thrust bearing (4), a rotor output shaft (5), a first planet gear (6), a first sun gear (7), a first planet carrier (8), an intermediate drive shaft (9), a second planet gear (10), a second sun gear (11), a second planet carrier (12), a third planet gear (13), a third sun gear (14), a third planet carrier (15), an output shaft (16), a third inner gear ring (17), a brake B3 (18), a second inner gear ring (19), a brake B2 (20), a clutch K2 (21), a clutch K1 (22), a first inner gear ring (23), a brake B1 (24), an oil pump (25), an oil pump input shaft (26), a motor stator (27), a motor housing (28) and a drive train housing (29), wherein:
the flexible coupling (1) is installed on a fly wheel of the vehicle engine and connected with the outer ring of the one-way clutch (2) of which the inner ring is connected with the front end of the input shaft (3);
the front segment of the input shaft (3) is provided with the motor housing (28); the middle segment of the input shaft (3) is connected with the first sun gear (7); the rear segment of the input shaft (3) is provided with the clutch K1 (22) and the clutch K2 (21);
the first sun gear (7) is engaged with the first planet gear (6); the first planet gear (6) is engaged with the first inner gear ring (23); the first planet gear (6) is arranged on the first planet carrier (8);
the second sun gear (11) is engaged with the second planet gear (10); the second planet gear (10) is engaged with the second inner gear ring (19); the second planet gear (10) is arranged on the second planet carrier (12);
the third sun gear (14) is engaged with the third planet gear (13); the third planet gear (13) is engaged with the third inner gear ring (17); the third planet gear (13) is arranged on the third planet carrier (15);
the motor stator (27) is arranged on the motor housing (28); the motor housing (28) is arranged on the input shaft (3); the rear portion of the motor housing (28) is connected with the oil pump input shaft (26) that is connected with the oil pump (25);
the rotor output shaft (5) is arranged on the bearing of the motor housing (28) and is connected with the first inner gear ring (23);
the first planet carrier (8) is connected with the second inner gear ring (19);
the second planet carrier (12) is connected with the third inner gear ring (17);
the third planet carrier (15) is connected with the output shaft (16);
the brake B1 (24), brake B2 (20) and brake B3 (18) all are arranged on the drive train housing (29);
the brake B1 (24) can stop the rotor output shaft (5) and the first inner gear ring (23); the brake B2 (20) can stop the first planet carrier (8) and the second inner gear ring (19); the brake B3 (18) can stop the second planet carrier (12) and the third inner gear ring (17); the clutch K1 (22) can connect the input shaft (3) and the intermediate drive shaft (9) as a whole; the intermediate drive shaft (9) is provided with the second sun gear (11) and the third sun gear (14); and the clutch K2 (21) can connect the input shaft (3), the second planet carrier (12) and the third inner gear ring (17) as a whole.

2. The drive train for an automatic transmission for an electromechanical hybrid vehicle according to claim 1, characterized in that the front segment of the input shaft (3) is provided with a motor housing (28); the motor housing (28) is provided with a motor stator (27); and a bearing of the motor housing (28) is provided with the rotor output shaft (5).
